(19) United States
(12) Patent Application Publication
(10) Pub. No.: US 2014/0241263 A1
(43) Pub. Date: Aug. 28, 2014

(54) ELECTRONIC DEVICE AND METHOD FOR REDUCING INTERFERENCE BETWEEN WIMAX AND WIFI

(71) Applicant: HON HAI PRECISION INDUSTRY CO., LTD., New Taipei (TW)

(72) Inventors: HSIN-LUNG TU, New Taipei (TW); CHIEN-PAN LAI, New Taipei (TW); JUI-FU CHANG, New Taipei (TW)

(21) Appl. No.: 13/907,991

(22) Filed: Jun. 3, 2013

(30) Foreign Application Priority Data
Feb. 22, 2013 (TW) 102106252

(51) Int. Cl. H04W 72/08

(52) U.S. Cl. CPC H04W 72/082
USPC 370/329

(57) ABSTRACT

A method for reducing interference between WiMAX signals and WiFi signals includes: obtaining a work frequency of the WiMAX module via the processor; comparing the work frequency of the WiMAX module with a preset frequency via the processor; and selecting a work frequency for the WiFi module according to the comparison result via the processor to make a difference between the work frequency of the WiFi module and the work frequency of the WiMAX module as greater as possible to reduce the interference between the WiFi module and the WiMAX module. An electronic device is also provided.

### BACKGROUND

1. Technical Field

The present disclosure relates to interference reducing technique in a wireless network and, particularly, to an electronic device and a method for reducing the interference between World Interoperability of Microwave Access (WiMAX) and Wireless Fidelity (WiFi).

2. Description of Related Art

When a difference between work frequencies of a WiMAX module and a WiFi module is not wide enough, the interference between WiMAX signals and WiFi signals may be great. Thus, it is desirable to provide a method to disclose how to assign work frequencies of the WiMax module and the WiFi module, causing the difference to be great enough to decrease the interference between the WiMax signals and the WiFi signals.

### BRIEF DESCRIPTION OF THE DRAWINGS

Many aspects of the present disclosure should be better understood with reference to the following drawings. The units in the drawings are not necessarily drawn to scale, the emphasis instead being placed upon clearly illustrating the principles of the present disclosure. Moreover, in the drawings, like reference numerals designate corresponding units throughout the several views.

FIG. 1 is a block diagram illustrating structure of an electronic device for reducing the interference between a WiMAX module and a WiFi module, in accordance with an exemplary embodiment.

FIG. 2 is a flowchart of a method for reducing the interference between WiMAX and WiFi in accordance with an exemplary embodiment.

### DETAILED DESCRIPTION

Embodiments of the present disclosure are described with reference to the accompanying drawings.

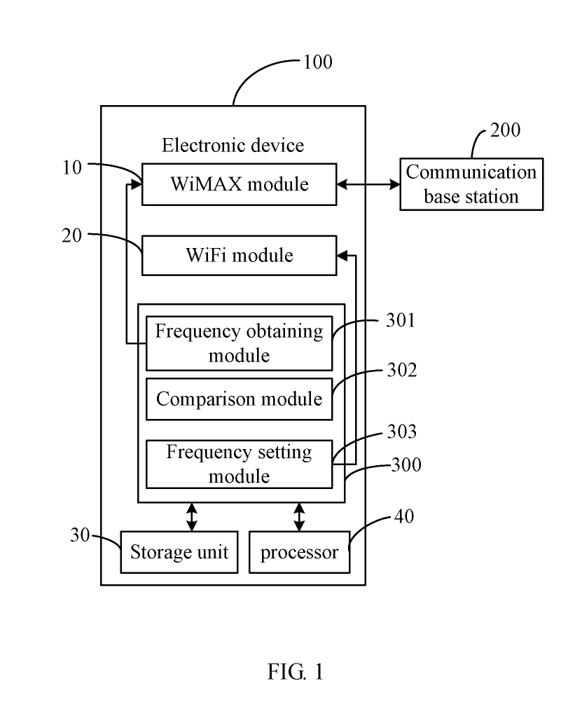

FIG. 1 shows an embodiment of the present disclosure of an electronic device 100. The electronic device 100 includes a WiMAX module 10, a WiFi module 20, a storage unit 30, and a processor 40. The WiMAX module 10 communicates with a communication base station 200. In this embodiment, the WiMAX module 10 operates in a first frequency range or a second frequency range. Each frequency value in the second frequency range is greater than each frequency value in the first frequency range. In this embodiment, the first frequency range is 2.3 GHz-2.4 GHz, and the second frequency range is 2.5 GHz-2.7 GHz. The communication base station 200 assigns a work frequency to the WiMAX module 10, and the work frequency may fall in the first frequency range or the second frequency range. The WiFi module 20 operates in a third frequency range. Each frequency value in the third frequency range is greater than each frequency value in the first frequency range and less than each frequency value in the second frequency range. In this embodiment, the third frequency range is 2.412 GHz-2.472 GHz. The third frequency range 2.412 GHz-2.472 GHz is equally divided into a number of units, that is, each of the units has an equal bandwidth. In this embodiment, the third frequency range 2.412 GHz-2.472 GHz are equally divided into thirteen units, the number of the units is an odd number.

The storage unit 30 may be a smart media card, a secure digital card, or a flash card. The storage unit 30 stores computerized codes of an interference reducing system 300. The interference reducing system 300 includes various software components and/or instructions implemented by the processor 40 to select a work frequency for the WiFi module 20 from the third frequency range according to the work frequency of the WiMAX module 10. The difference between the work frequency of the WiFi module 20 and the work frequency of the WiMAX module 10 is greater, the interference between the WiFi module 10 and the WiMAX module 20 is less.

The interference reducing system 300 includes a frequency obtaining module 301, a comparison module 302, and a frequency setting module 303.

The frequency obtaining module 301 includes various components and/or instructions, which may be implemented by the processor 40 to obtain the work frequency of the WiMAX module 10 assigned by the communication base station 200.

The comparison module 302 includes various components and/or instructions implemented by the processor 40 to compare the work frequency of the WiMAX module 10 with a preset frequency. In this embodiment, the preset frequency is 2.6 GHz, within the second frequency range 2.5 GHz-2.7 GHz. In other embodiments, the preset frequency may be other values in the first frequency range or the second frequency range.

The frequency setting module 303 includes various components and/or instructions, which may be implemented by the processor 40 to select a frequency for the WiFi module 20 from the third frequency range according to the comparison result, and set the selected frequency as the work frequency of the WiFi module 20.

In detail, in this embodiment, when the comparison module 302 determines that the work frequency of the WiMAX module 10 is greater than the preset frequency 2.6 GHz, the frequency setting module 303 determines a middle unit of the number of units of the third frequency range, and selects a frequency, which is equal to or less than a center frequency of the middle unit, as the work frequency of the WiFi module 20. In other embodiments, if the number of the units is a even number, such as fourteen, and there are two middle positioned units, the frequency setting module 303 may selects the unit whose frequency is less than the other one in the two middle positioned units as the middle unit. For example, when the work frequency of the WiMAX module 20 is 2.69 GHz, which is greater than the preset frequency 2.6 GHz, the frequency setting module 303 may set a center frequency 2.442 GHz of the seventh unit as the frequency of the WiFi module 10. As the difference between the work frequencies of the WiMAX module 20 and the WiFi module 10 is great enough, the interference between the WiFi module 10 and the WiMAX module 20 may not affect the communication.

When the comparison module 302 determines that the work frequency of the WiMAX module 20 is less than the preset frequency, the comparison module 302 is further operated by the processor 40 to determine the work frequency of the WiMAX module 10 falls in which of the first frequency range or the second frequency range.

When the comparison module 302 determines that the work frequency of the WiMAX module 20 falls within the first frequency range, the frequency setting module 303 regards a predetermined number of units whose frequencies are lower than remaining units as unusable units, regards the remaining units as usable units, and selects a highest frequency from the unemployed frequencies of the usable units as the work frequency of the WiFi module 20. In this embodiment, as the difference between each frequency in the units whose frequencies are lower and the work frequency of the WiMAX module 10 is too small, the interference may be greater if one lower frequency is selected as the work frequency of the WiFi module 20. Thus, the frequency setting module 303 regards the lower frequencies as unusable frequencies. For example, when the comparing module 302 determines that the work frequency of the WiMAX module 10 is in the first frequency range, the frequency setting module 303 regards the frequencies in the first, second, and third units as unusable frequencies. When the highest frequency in the thirteenth unit is not employed, the frequency setting module 303 sets the highest frequency in the thirteenth unit as the work frequency of the WiFi module 20. When all the frequencies of the thirteenth unit have been employed and the highest frequency of the twelfth unit is not employed, the frequency setting module 303 sets the highest frequency of the twelfth unit as the work frequency of the WiFi module 20.

When the comparison module 302 determines that the work frequency of the WiMAX module 10 falls within the second frequency range, the frequency setting module 303 regards a predetermined number of units whose frequencies are higher than remaining units as unusable units, regards the remaining units as usable units, and selects a lowest frequency from the unemployed frequencies of the usable units as the work frequency of the WiFi module 20.

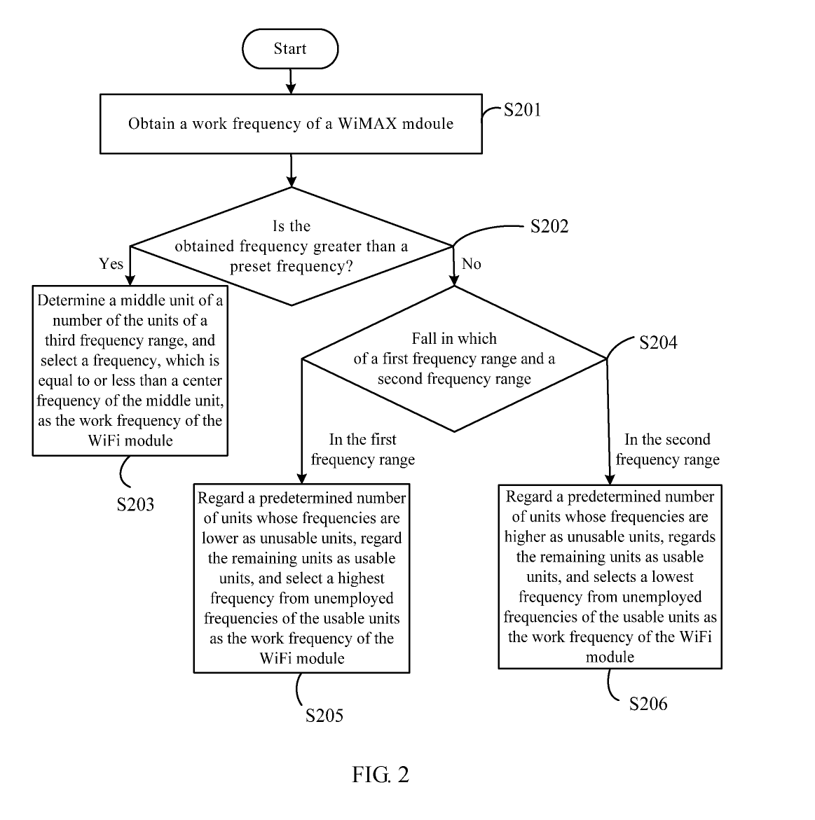

FIG. 2 is a flowchart of a method for reducing the interference between WiMAX signals and WiFi signals, in accordance with an exemplary embodiment.

In step S201, the frequency obtaining module 301 obtains a work frequency of the WiMAX module 10 assigned by the communication base station 200.

In step S202, the comparison module 302 compares the work frequency of the WiMAX module 10 with a preset frequency to determine whether the frequency of the WiMAX module is greater than the preset frequency. In this embodiment, the preset frequency value falls within the second frequency range. If the comparison module 302 determines that the frequency of the WiMAX module 20 is greater than the preset frequency, the procedure goes to step S203, otherwise, the procedure goes to step S204.

In step S203, the frequency setting module 303 determines a middle unit of the number of the units of the third frequency range, and selects a frequency, which is equal to or less than a center frequency of the middle unit, as the work frequency of the WiFi module 20.

In step S204, the comparing module 302 determines which frequency range the work frequency of the WiMAX module 10 falls in. If the work frequency of the WiMAX module 10 falls within the first frequency range, the procedure goes to step S205, and if the work frequency of the WiMAX module 10 falls within the second frequency range, the procedure goes to step S206.

In step S205, the frequency setting module 303 regards a predetermined number of units whose frequencies are lower as unusable units, regards the remaining units as usable units, and selects a highest frequency from the unemployed frequencies of the usable units as the work frequency of the WiFi module 20.

In step S206, the frequency setting module 303 regards a predetermined number of units whose frequencies are higher as unusable units, regards the remaining units as usable units, and selects a lowest frequency from the unemployed frequencies of the usable units as the work frequency of the WiFi module 20.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An electronic device comprising:
a World Interoperability of Microwave Access (WiMAX) module;
a Wireless Fidelity (WiFi) module;
a storage unit;
a processor; and
an interference reducing system comprising computerized codes in the form of one or more programs, which are stored in the storage unit and executable by the processor, the one or more programs comprising:
a frequency obtaining module operable to obtain a work frequency of the WiMAX module;
a comparison module operable to compare the work frequency of the WiMAX module with a preset frequency; and
a frequency setting module operable to select a frequency for the WiFi module according to the comparison result, and set the selected frequency as the work frequency of the WiFi module.

2. The electronic device as described in claim 1, wherein the work frequency of the WiMAX module falls in a first frequency range or a second frequency range, each frequency value in the second frequency range is greater than each frequency value in the first frequency range; the work frequency of the WiFi module falls in a third frequency range, each frequency value in the third frequency range is greater than each frequency value in the first frequency range and less than each frequency value in the second frequency range, the third frequency range is equally divided into a plurality of units; when the comparison module determines that the work frequency of the WiMAX module is greater than the preset frequency, the frequency setting module determines a middle unit of the number of units of the third frequency range, and selects a frequency, which is equal to or less than a center frequency of the middle unit as the work frequency of the WiFi module.

3. The electronic device as described in claim 2, wherein when the comparison module determines that the work frequency of the WiMAX module is less than the preset frequency, the comparison module is further operable to determine the work frequency of the WiMAX module falls in which of the first frequency range and the second frequency range, and when the comparison module determines that the work frequency of the WiMAX module falls within the first frequency range, the frequency setting module regards a predetermined number of units whose frequencies are lower than remaining units as unusable units, regards the remaining units as usable units, and selects a highest frequency from unemployed frequencies of the usable units as the work frequency of the WiFi module.

4. The electronic device as described in claim 3, wherein when the comparison module determines that the work frequency of the WiMAX module falls within the second frequency range, the frequency setting module regards a predetermined number of units whose frequencies are higher than remaining units as unusable units, regards the remaining units as usable units, and selects a lowest frequency from unemployed frequencies of the usable units as the work frequency of the WiFi module.

5. A method for reducing interference between WiMAX signals and WiFi signals applied in an electronic device, the electronic device comprising a WiMAX module, a WiFi module, and a processor, a work frequency of the WiMAX module being falled in a first frequency range or a second frequency range, each frequency value in the second frequency range is greater than each frequency value in the first frequency range; a work frequency of the WiFi module being falled in a third frequency range, each frequency value in the third frequency range is greater than each frequency value in the first frequency range and less than each frequency value in the second frequency range, the third frequency range being equally divided into a plurality of units, the method comprising:
obtaining a work frequency of the WiMAX module via the processor;
comparing the work frequency of the WiMAX module with a preset frequency via the processor; and
selecting a frequency for the WiFi module according to the comparison result via the processor, and setting the selected frequency as the work frequency of the WiFi module.

6. The method as described in claim 5, wherein the method “selecting a frequency for the WiFi module according to the comparison result” further comprising:
determining a middle unit of the number of units of the third frequency range, and selecting a frequency, which is equal to or less than a center frequency of the middle unit as the working frequency of the WiFi module via the processor when determining that the work frequency of the WiMAX module is greater than the preset frequency;
determining the work frequency of the WiMAX module falls in which of the first frequency range and the second frequency range when determining that the work frequency of the WiMAX module is less than the preset frequency;
regarding a predetermined number of units whose frequencies are lower as unusable units, regards the remaining units as usable units, and selecting a highest frequency from unemployed frequencies of the usable units as the work frequency of the WiFi module when determining that the work frequency of the WiMAX module falls within the first frequency range; and
regarding a predetermined number of units whose frequencies are higher as unusable units, regarding the remaining units as usable units, and selecting a lowest frequency from unemployed frequencies of the usable units as the work frequency of the WiFi module.
